(19) United States
(12) Patent Application Publication
(10) Pub. No.: US 2012/0164516 A1
(43) Pub. Date: Jun. 28, 2012

(54) STORAGE ELEMENT FOR ELECTRIC ENERGY AND METHOD FOR PRODUCING A STORAGE BLOCK

(75) Inventors: Jens Meintschel, Bernsdorf (DE); Juergen Hofmann, Kamenz (DE); Claus-Rupert Hohenthanner, Hanau (DE); Torsten Schmidt, Landsberg (DE)

(73) Assignee: LI-TEC BATTERY GMBH, Kamenz (DE)

(21) Appl. No.: 13/254,095

(22) PCT Filed: Feb. 26, 2010
(86) PCT No.: PCT/EP10/01217

§ 371 Date: Mar. 14, 2012

(30) Foreign Application Priority Data
Mar. 3, 2009 (DE) 10 2009 011 523.4

(51) Int. Cl. H01M 2/20; H01G 9/00; H01G 4/00; H01M 2/02; H01M 10/04

(52) U.S. Cl. 429/162; 29/623.1; 29/25.41; 361/500

(57) ABSTRACT

The assembly or design of the energy conductors (103, 104, 502) of a storage element (101, 305, 501) for electric energy has specific assembly or design elements (201, 202, 203, 204, 301, 302, 303, 404, 405, 406, 407, 412, 413), which counteract a polarity reversal of the storage element or storage elements upon assembly of such storage elements with other similar storage elements to form a storage block, or upon connection of a storage block to an energy consumer or energy supplier equipped with corresponding contact or retaining elements.

Priority application DE 10 2009 011 523.4 is fully incorporated by reference into the present application.

The invention relates to a storage element for electric energy and a method for producing a storage block from such storage elements.

Storage elements for electric energy are used in many areas of engineering in the most varied forms. Important examples of such storage elements are capacitors and galvanic cells.

In some applications, for example in solar clocks and similar products, capacitors are preferred as storage elements. For other applications, for example for portable miniaturised devices such as mobile telephones or notebook computers and similar products, storage elements based on the principle of the galvanic cell are more advantageous.

The types of storage elements for electric energy mentioned, as in principle all types, can be either directly connected to an energy consumer or connected together to other—typically similar—storage elements to form so-called storage blocks (batteries). In a parallel connection of storage elements, in which electrodes of the same polarity are connected together, the storage capability (the capacity) of the storage block increases due to their being interconnected. The voltage between the interconnected electrodes remains unchanged with the parallel connection.

In the case of a series connection, in which electrodes of different polarity are connected together in the form of a chain, the voltage between the free electrodes of the storage block increases. Depending on the requirements of the respective application therefore, parallel connections or series connections of storage elements to form storage blocks, or the direct connection of a storage element to an energy consumer, are typical.

In all forms of application of such storage elements it is always important to prevent accidental polarity reversal of the electrodes. This problem occurs because the electrodes, which are also known as collectors or collector plates, are frequently designed as simple metal plates, which frequently simply protrude from a usually foil-like packaging of the storage element or the storage block in order to be connected via contact elements joined to these collector plates by either positive-fitting, force-fitting or material bonds to the energy consumer or (in the charging process) to an energy source, or (during assembly of a storage block) to be electrically connected to collectors of other storage elements.

If such polarity reversals occur, that is, incorrect electrical connections between the collectors of storage elements or between collectors and connection elements of energy consumers or energy sources, then damage to the application systems or to the storage elements due to overvoltages or short-circuit currents are the typical consequences of such errors.

The object then addressed by the present invention is to specify a technical method for preventing such errors. This object is achieved according to the invention by a storage element for electric energy or by a method for producing a storage block from such storage elements according to one of the independent claims.

Advantageous extensions of the invention form the subject matter of dependent claims.

According to the present invention a storage element for electric energy is provided, having at least two electric collectors of opposing electrical polarity for collecting the energy stored in the storage element, in which the arrangement or design of at least one of the collectors has particular assembly or design elements. These particular assembly or design elements counteract a polarity reversal of the storage element or the storage elements upon the assembly of storage elements according to the invention with other similar storage elements to form a storage block, or upon connecting such a storage element or a storage block assembled from such storage elements to an energy consumer or energy supplier equipped with corresponding contact or insulation elements.

The terms assembly elements or design elements in connection with the present designs are to be understood to mean any conceivable type of elements for configuring the assembly or the form of the objects to which these terms respectively refer. A use of these terms in the plural is not necessarily intended to mean that a plurality of such elements must be used in every embodiment of the present invention. The use of a plurality of such elements however is not in any way excluded either.

In a preferred embodiment of such a storage element, the assembly or the design of at least one of its collectors—alone or in cooperation with corresponding contact or insulation elements—supports the assembly of the storage element with other similar storage elements to form a storage block.

Particularly preferred is in addition a storage element having at least one collector, the particular assembly or design elements of which correspond to geometric patterns, which correspond to a coding of the polarity of this collector.

For the assembly of storage blocks in particular, a storage element with at least one collector is particularly preferred, which is configured such that it can be electrically connected via contact elements to collectors of other similar storage elements when assembling such storage elements to form a storage block, or electrically insulated from these with the aid of insulation elements and the particular assembly or design elements of which upon assembly of such storage elements in the intended manner engage with corresponding assembly or design elements of the contact elements or of the insulation elements, in order to counteract a polarity reversal of the storage elements.

A particularly advantageous extension of such a storage element has at least one collector, the particular assembly or design elements of which are configured as a stub or hole or as a geometric pattern or an arrangement of such stubs or holes, which upon assembly of such storage elements in the intended manner engage with a corresponding stub or a corresponding hole or with a geometric pattern or an arrangement of such stubs or holes in the contact elements or in the insulation elements.

Additionally particularly preferred is a storage element having at least one collector, the particular assembly or design elements of which are configured such that they—alone or in cooperation with corresponding contact or insulation elements—prevent an incorrect assembly of storage elements, or in the event of incorrect assembly of storage elements prevent an incorrect electrical contacting, or at least result in a striking divergence of the shape of the assembled storage block from its intended shape.

Further particular advantages result from a storage element according to the invention having at least one collector, the assembly or particular assembly or design elements of which are configured such that they—alone or in cooperation with corresponding contact or insulation elements—support or enforce a positioning of the storage elements in the intended manner when assembling such storage elements to form a storage block.

These advantages can be achieved in particular with a storage element in which the shape and/or the arrangement of the stubs and/or the holes support or enforce a positioning of the storage elements in the intended manner when assembling such storage elements to form a storage block.

According to the present invention moreover, a method is provided for producing a storage block from a plurality of storage elements for electric energy, each having at least two electric collectors of opposing electrical polarity for collecting the energy stored in the respective storage element, in which the storage elements are assembled with other similar storage elements to form a storage block, after the assembly or design of at least one of the collectors of all or at least some of these storage elements has been configured prior to the assembly with particular assembly or design elements which counteract a polarity reversal of the storage elements when assembling such storage elements to form a storage block.

Particularly preferred in this context is a method for producing a storage block in which the correct positioning of the storage elements in the storage block in the intended manner during the assembly is supported by the assembly or design of at least one of the collectors of all or at least some of these storage elements.

The present invention is described in more detail below with the aid of exemplary embodiments and of the Figures.

They show:

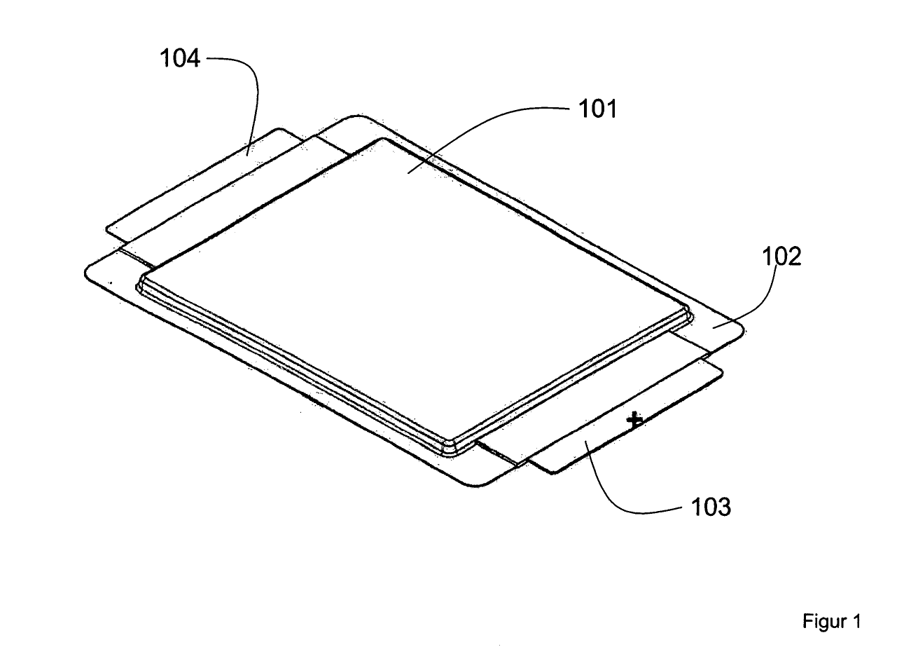

FIG. 1 an example of the external appearance of a storage element for electric energy according to the prior art;

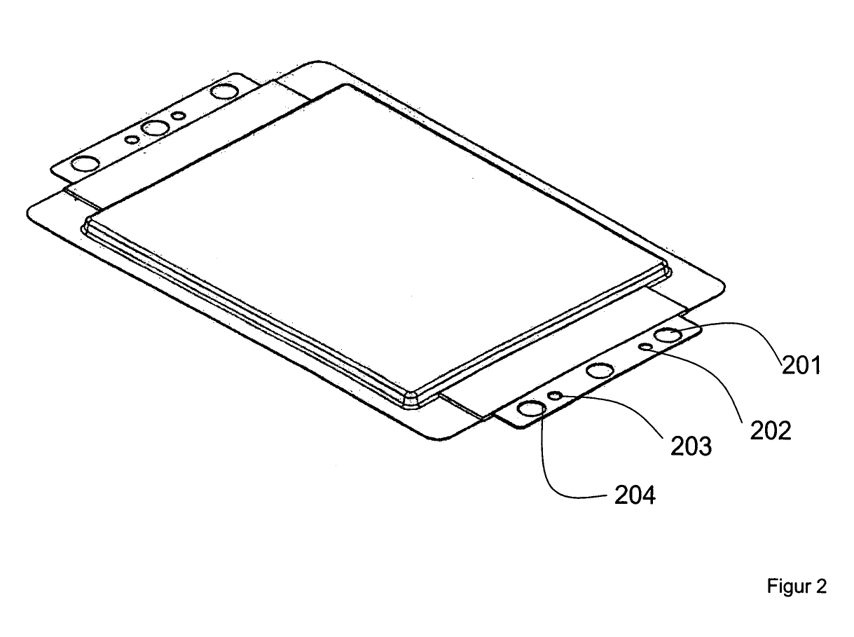

FIG. 2 an exemplary embodiment of a storage element for electric energy according to the invention;

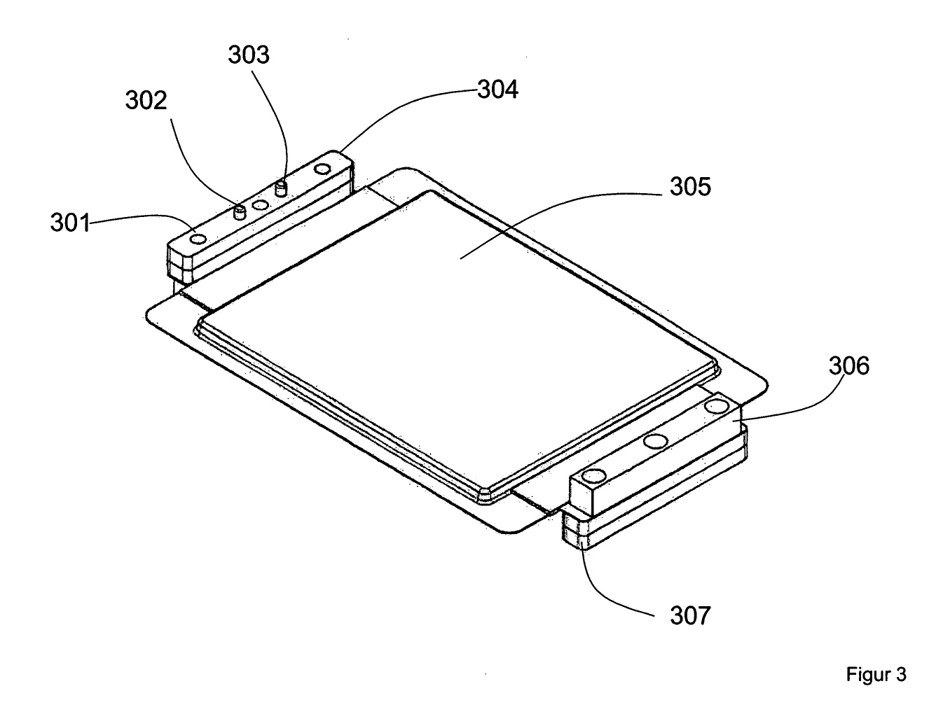

FIG. 3 an exemplary embodiment of a storage element for electric energy (cell) according to the invention, having contact or insulation elements connected thereto for assembling a storage block (cell block);

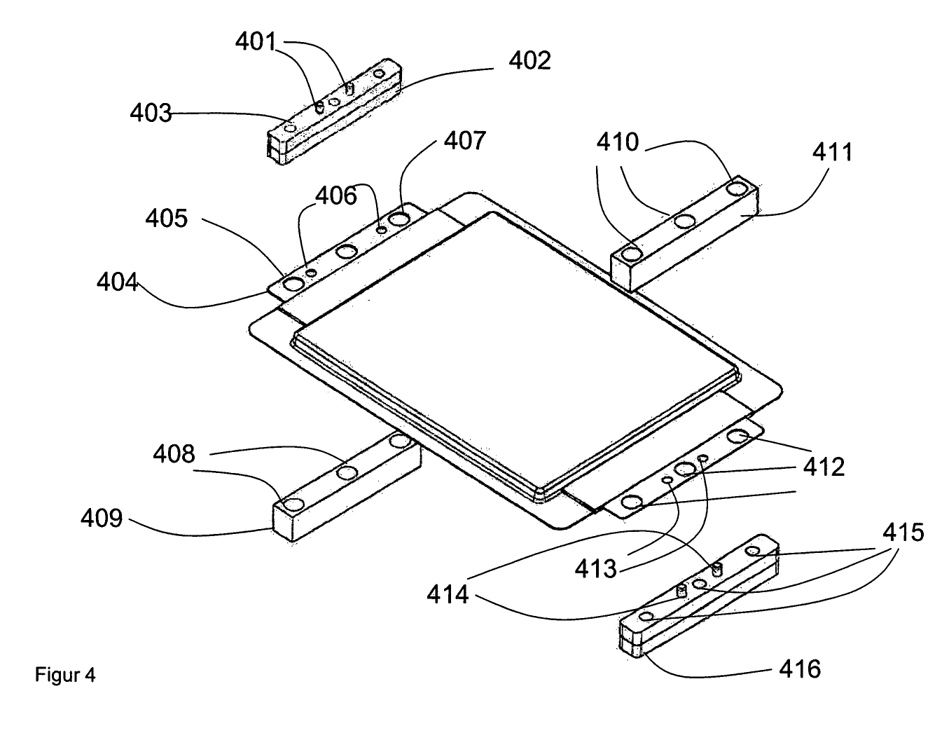

FIG. 4 an exploded view of the exemplary embodiment of a storage element according to the invention for electric energy (cell) shown in FIG. 3 with contact or insulation elements connected thereto for assembling a storage block (cell block);

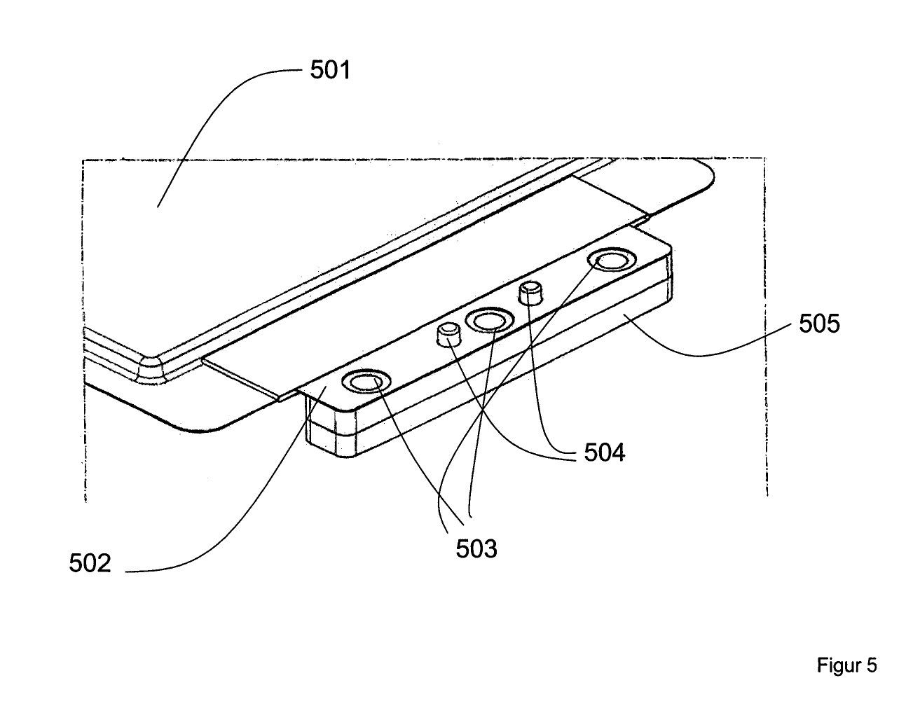

FIG. 5 an enlarged view of a collector of an exemplary embodiment of a storage element for electric energy according to the invention and

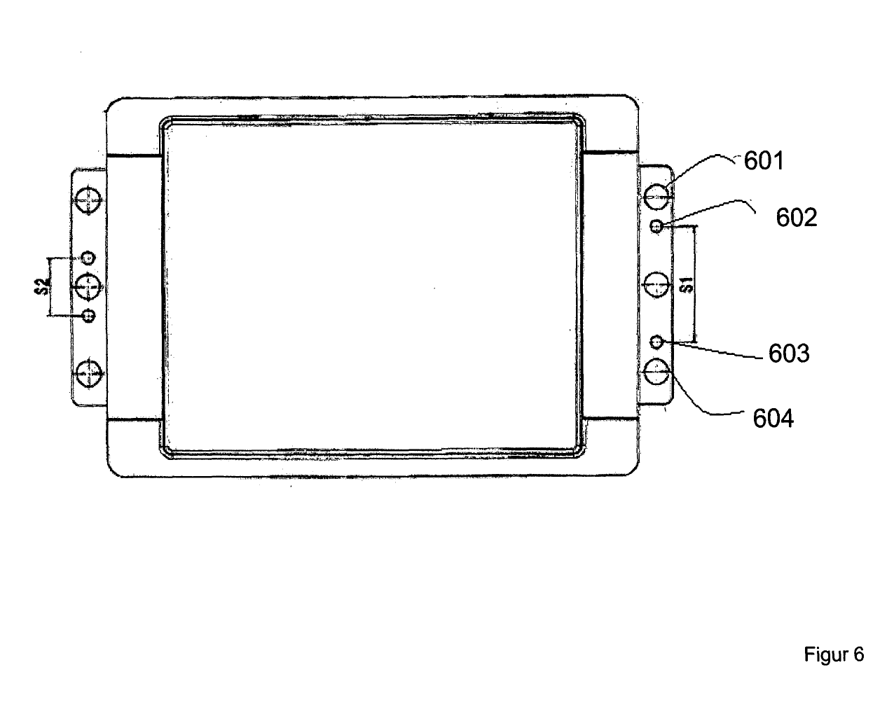

FIG. 6 a plan view of an exemplary embodiment of a storage element for electric energy according to the invention.

According to the present invention a storage element (101, 305) for electric energy is provided, having at least two electric collectors (103, 104) of opposing electrical polarity for collecting the energy stored in the storage element, in which the assembly or design of at least one of the collectors (103, 104) has particular assembly or design elements (202, 203). These particular assembly or design elements (202, 203) counteract a polarity reversal of the storage element or the storage elements upon the assembly of storage elements according to the invention with other similar storage elements to form a storage block, or upon connecting such a storage element or a storage block assembled from such storage elements to an energy consumer or energy supplier equipped with corresponding contact or insulation elements.

As shown in FIG. 1 by the example of a so-called pouch cell or coffee-bag cell, the often very simple design of the collector plates (103, 104) is associated with a considerable risk of confusion, which often leads in practice to polarity reversals of the storage elements, i.e. to incorrect electrical connections between their collectors or between the collectors and electrical contacts connected thereto. Such storage elements are frequently electrochemical (galvanic) cells, the electrochemically active content of which is frequently enclosed by a foil-like packaging (102), through which the electrical connections (which are also referred to as collectors, electrodes, or similar) are passed.

The present invention however can also be implemented in combination with other storage elements, e.g. with capacitors, and the present embodiments therefore apply analogously to all types of electric storage elements and storage blocks produced from such storage elements. The electric voltage is frequently tapped off at these collectors via contact elements joined to these collector plates by either positive-fitting, force-fitting or material bonds. These can connect to the collectors on one or both sides.

Often, one contact element is located on the one side of a collector and an insulation element or a retaining element on the other side. Such retaining element can serve to press a contact element against a collector, or to position the storage element or the storage block differently in a stable manner within the application. Such retaining elements will frequently be insulation elements, unless a collector is intended, for example, to conduct the electric potential of a device housing.

When individual cells are used the contact elements are directly or indirectly connected to the electric power consumers or power sources. In the case of storage blocks (batteries, cell blocks, etc.) contacting and insulation elements are used to form a parallel or series circuit of storage elements within the storage block, depending on the requirements of the application.

With the aid of FIGS. 3 and 4 it can be easily seen how an advantageous combination of contact and insulation elements (304, 306, 307) can be used in suitable combination with the collectors of a storage element (305) according to the invention for the simple construction of a storage block in a parallel or series circuit of storage elements according to the invention.

If, for example, by stacking a plurality of assemblies shown in FIGS. 3 and 4 consisting of a storage element (305) and contact and insulation elements (304, 306, 307) a series circuit of storage elements is to be built for example, then in order to do so, for example, electrically conducting contact elements (304) are applied to the upper sides of the negative collectors (cathodes), and the upper sides of the positive collectors (anodes) are covered with insulation elements (306).

If now, as is provided according to the invention in this exemplary embodiment, the spacing and the size of the stubs (401, 414) applied to the contact or insulation elements (304, 402, 416) match the spacing and the size of the holes (406, 413) provided in the collectors according to this exemplary embodiment of the invention, then these measures counteract an incorrect electric contacting, because an accidental incorrect alignment of a storage element when assembling the storage block would be more difficult or even prevented, or at least would be immediately noticed.

The teaching according to the invention therefore has the effect that, when assembling storage blocks in series, only collectors of different polarity can be connected to one another. The same applies to the assembly of storage blocks in parallel, in which the most important issue is to ensure that only collectors of the same polarity are connected to one another.

The same also applies to other embodiments of the invention in which, instead of stubs and holes or instead of a geometric pattern or an arrangement of such stubs or holes, a different kind of assembly or design of at least one of the collectors (103, 104) or of the contact or insulation elements, or different combinations of assemblies or designs of such collectors or contact or insulation elements with different kinds of particular assembly or design elements (201, 202, 203, 204) can be used, which counteract a polarity reversal of the galvanic cell or cells upon the assembly of such storage elements with other, in particular similar, storage elements to form a storage block or upon connecting the storage element or a storage block composed of such storage elements to an energy consumer or energy supplier equipped with corresponding contact or insulation elements.

An important idea of the present invention consists—formulated in other words—of providing the collectors, the contact elements connected thereto and/or the insulation or retaining elements connected thereto, with a “geometric coding” which counteracts a polarity reversal of the cells, or even prevents this. If a cell according to the invention is installed in a laterally reversed manner (i.e. incorrectly), then the properties of the collectors, or the contacting, insulation or retaining elements which code the electrical polarity of the electrodes “in a geometric manner”—i.e. by means of their particular assembly or design elements—either prevent the electrical contact and/or the assembly or installation of the storage elements or clearly and noticeably signal the error to the assembly operator, for example by eccentric or offset arrangement of the storage element in the storage block.

The elements for geometrically coding the electrical polarity, that is, the assembly or design of the collectors (103, 104), their particular assembly or design elements (201, 202, 203, 204, 301, 302, 303, 404, 405, 406, 407, 412, 413) or the corresponding assembly or design elements (401, 403, 408, 410, 414, 415) of the contact, insulation or retaining elements to be used with the collectors, can be—depending on the embodiment of the invention—for example, patterns with variable spacings or numbers of holes, notches, elevations, stubs, noses, grooves, webs or similar assembly or design elements (201, 202, 203, 204, 301, 302, 303, 401, 403, 404, 405, 406, 407, 408, 410, 412, 413, 414, 415). Even the size, the shape or the particular arrangement of a collector (angle, position in the cell, etc.) or its specific design itself (forked, bent, etc.) can already represent such a “geometric coding” of the polarity, which only when the storage element is correctly positioned in relation to corresponding counterparts, such as corresponding contact or insulation elements, engage with the corresponding assembly and design elements of these counterparts in the intended manner.

The invention is particularly advantageous when the coding of the collectors according to the invention is carried out before completion of the manufacturing process of the storage element, because this measure can be used to counteract a polarity reversal of the storage element later in the manufacturing process. Where this is not possible, a coding of the collectors of storage elements originally not provided with coded collectors is recommended before the assembly of storage blocks, in order to counteract a polarity reversal during assembly.

As illustrated in FIGS. 2, 3, 4, 5 and 6 using the example of a flat pouch ceil, the invention can be implemented with nothing more than simple patterns of holes (202, 203) or (406, 413), which according to the application and embodiment of the invention fit together with corresponding hole patterns and/or stub patterns (301, 302, 303, 401, 403, 408, 410, 412, 414, 415) in corresponding contact or insulation elements (304, 306, 307, 402, 409, 411, 416).

FIG. 5 shows in detail how the stubs (504) or the holes (503) of a contact or insulation element (505) mate with the corresponding holes of the collector (502) of a storage element (501) that is connected to such an element either purely mechanically or also electrically.

In plan view, FIG. 6 shows how a polarity reversal can be counteracted by simple choice of different spacings (S1, S2) of coding holes (602, 603). These coding holes can if required, as is also shown in FIG. 4, easily be applied in the collector in addition to possibly already existing coding or non-coding holes (405, 407, 410, 412, 601, 604) merely used to provide stable mounting, where appropriate depending on the embodiment of the invention.

A suitable design of the assembly or design elements of the collectors and/or the contact or insulation elements results in the additional advantage that a storage element according to the invention, by means of its design or assembly, or by means of the assembly or the design of one of its collectors (103, 104, 502)—alone or in cooperation with corresponding contact or insulation elements (402, 409, 411, 416)—supports the assembly of the storage element with other similar storage elements to form a storage block. This is for example the case when the shape of the pouch or coffee-bag cells supports stacking to form a storage block, or when the assembly or the design of the collectors (103, 104, 502) or of the corresponding contact or insulation elements (402, 409, 411, 416) supports stacking to form a storage block, as is the case in the embodiments shown in FIGS. 3 and 4.

In this exemplary embodiment the matched arrangements and chosen dimensions of stubs and holes even support a intended positioning of the storage elements during their assembly to form a storage block, since an interlocking of these assembly and design elements according to specification necessarily assumes a positioning of the storage elements according to specification.

1. A flat electrochemical storage element (101, 305, 501) for electric energy having at least two flat electric collector plates (103, 104, 502) of opposing electrical polarity for collecting the energy stored in the storage element, the electrochemically active contents of which are enclosed by a flat, foil-like packaging (102), through which the flat collector plates are passed,
wherein
the design of at least one of the collectors (103, 104, 502) has particular holes (406, 413), notches, elevations, stubs (401, 414), noses, grooves or webs which
a) upon assembly of such storage elements with other similar storage elements to form a storage block or
b) upon connecting the storage element or a storage block composed of such storage elements to an energy consumer or energy supplier equipped with corresponding contact or insulation elements counteract a polarity reversal of the storage element or the storage block in cooperation with corresponding contact or insulation elements, as
c) the spacing and the size of the holes (406, 413), notches, elevations, stubs (401, 414), noses, grooves or webs of the contact or insulation elements (304, 402, 416) that are used match the holes (406, 413), notches, elevations, stubs (401, 414), noses, grooves or webs provided in the collectors.

2. The storage element according to claim 1, the design or assembly of which, or in which the assembly or the design of at least one of its collectors (103, 104, 502) alone or in cooperation with corresponding contact or insulation elements (402, 409, 411, 416) supports the assembly of the storage element with other similar storage elements to form a storage block.

3. The storage element according to claim 1, having at least one collector, the particular assembly or design elements (201, 202, 203, 204, 301, 302, 303, 404, 405, 406, 407, 412, 413) of which correspond to geometric patterns which correspond to a coding of the polarity of this collector.

4. The storage element according to claim 3, having at least one collector (103, 104, 502), which
a) is configured such that it can be electrically connected via contact elements to collectors of other similar storage elements upon assembling such storage elements to form a storage block, or electrically insulated from these with the aid of insulation elements, and
b) the particular assembly or design elements (201, 202, 203, 204, 301, 302, 303, 404, 405, 406, 407, 412, 413) of which, upon assembly of such storage elements (101, 305, 501) in the intended manner, engage with corresponding assembly or design elements (401, 403, 408, 410, 414, 415) of the contact elements or of the insulation elements in order to counteract a polarity reversal of the storage elements.

5. The storage element according to claim 4, having at least one collector, the particular assembly or design elements (201, 202, 203, 204, 301, 302, 303, 404, 405, 406, 407, 412, 413) of which are configured as a stub or hole or as a geometric pattern or an arrangement of such stubs or holes, which upon assembly of such storage elements in the intended manner engage with a corresponding stub or a corresponding hole or with a geometric pattern or an arrangement of such stubs or holes (301, 302, 303, 401, 403, 408, 410, 412, 414, 415) in the contact elements or in the insulation elements.

6. The storage element according to claim 5, having at least one collector, the particular assembly or design elements (201, 202, 203, 204, 301, 302, 303, 404, 405, 406, 407, 412, 413) of which are configured such that they, alone or in cooperation with corresponding contact or insulation elements, prevent an incorrect assembly of storage elements.

7. The storage element according to claim 6, having at least one collector, the particular assembly or design element (201, 202, 203, 204, 301, 302, 303, 404, 405, 406, 407, 412, 413) of which are configured such that they alone or in cooperation with corresponding contact or insulation elements, prevent an incorrect electrical contacting in the event of an incorrect assembly of storage elements.

8. The storage element according to claim 7, having at least one collector, the assembly or particular assembly or design elements (201, 202, 203, 204, 301, 302, 303, 404, 405, 406, 407, 412, 413) of which are configured such that they, alone or in cooperation with corresponding contact or insulation elements, result in a striking divergence of the shape of the assembled storage block from its intended shape in the event of an incorrect assembly of storage elements.

9. The storage element according to claim 8, having at least one collector, the assembly or particular assembly or design elements (201, 202, 203, 204, 301, 302, 303, 404, 405, 406, 407, 412, 413) of which are configured such that they, alone or in cooperation with corresponding contact or insulation elements, upon assembling such storage elements to form a storage block, support or enforce a positioning of the storage elements in the intended manner.

10. The storage element according to claim 5, in which, upon assembling such storage elements to form a storage block, the shape and/or the arrangement of the stubs and/or holes support or enforce a positioning of the storage elements in the intended manner.

11. A method for producing a storage block from a plurality of storage elements for electric energy, each having at least two electric collectors (103, 104) of opposing electrical polarity for collecting the energy stored in the respective storage element,
wherein
a) the storage elements are assembled together with other similar storage elements to form a storage block, after
b) the assembly or design of at least one of the collectors (103, 104) of all or at least some of these storage elements has been configured prior to the assembly with particular assembly or design elements (201, 202, 203, 204, 301, 302, 303, 404, 405, 406, 407, 412, 413) which counteract a polarity reversal of the storage elements upon assembling such storage elements to form a storage block.

12. The method for producing a storage block according to claim 11 , in which the correct positioning of the storage elements in the storage block in the intended manner during assembly is supported by the assembly or design of at least one of the collectors (103, 104) of all or at least some of these storage elements.
